(19) United States
(12) Patent Application Publication
(10) Pub. No.: US 2020/0376906 A1
(43) Pub. Date: Dec. 3, 2020

(54) SYSTEM AND METHOD FOR ASSOCIATING TIRE INFORMATION WITH TOWABLE RIG INFORMATION

(71) Applicant: Tredit Tire & Wheel Company, Inc., Elkhart, IN (US)

(72) Inventors: Michael L. GEROWITZ, Elkhart, IN (US); Joshua A. HOSTETLER, Elkhart, IN (US); Jeffrey L. STEVENS, Elkhart, IN (US)

(21) Appl. No.: 16/885,502

(22) Filed: May 28, 2020

Related U.S. Application Data
(60) Provisional application No. 62/854,436, filed on May 30, 2019.

(51) Int. Cl. B60C 23/04; G06Q 30/00

(52) U.S. Cl. CPC B60C 23/0416; G06Q 30/016; G06Q 30/014

(57) ABSTRACT

A computerized method for associating at least one tire, a rig, and a consumer of the at least one tire and the rig with one another includes receiving a tire identification number (TIN) with a tire in a database record maintained in a database by a computer. The method further includes receiving a vehicle identification number (VIN) with a rig in the database record, and receiving and linking by the computer at least one TIN with the VIN in the database record when the corresponding tire is assembled to the corresponding rig to configure a trailer, and receiving a consumer identifier of the trailer in the database record for association with the corresponding tire and the corresponding rig.

### CROSS-REFERENCE TO RELATED APPLICATIONS

This application claims priority of U.S. Provisional Application Ser. No. 62/854,436 filed May 30, 2019, which is incorporated herein by reference.

### TECHNICAL FIELD

Generally, the present invention is directed to a system and method for associating tire information with towable rig information. Specifically, the invention is directed to a system and method for receiving and linking tire information with towable rig information so as to comply with government safety requirements, facilitate inventory control, and assist with future product ordering.

### BACKGROUND ART

Currently, there is a deficiency in associating and linking consumers, and in particular end-purchasers, with tires (and associated tire information) that they have purchased that are either pre-installed on a towable rig or as replacement tires for use with the rig. As used herein, the towable rig may be any configuration which uses any number of tires to support a structure as it is towed, pushed, or pulled by another vehicle. Such rigs include, but are not limited to, a trailer, a boat trailer, a recreational vehicle, generators, campers, construction equipment, farm implements, and the like.

The aforementioned deficiency is primarily in associating consumers, such as rig or trailer manufacturers, dealers, and end-purchasers, with the purchased tires and the associated tire information for use with the rig. This information is needed in case there are any safety recall notices for the tires and to document ownership of the purchased tires for warranty purposes. Typically, an end-purchaser is provided with a warranty card in which they provide their contact and tire identifying information on the card for the tires that they have purchased. In some instances, the prescribed from may be issued by a government agency such as the National Highway Traffic Safety Administration. In any case, the warranty card is then mailed or emailed to the tire manufacturer. It is estimated that only about one percent of these cards are ever returned to the tire manufacturer. And, even if the cards are returned, the consumer and tire information is often retained in a haphazard manner that limits the ability of the manufacturer to contact consumers if a tire safety issue arises.

Clearly, there is a need in the art for a system and method for associating the purchased tires, either replacement tires or those tires supplied with the rig, to an end-purchaser. It is believed that such a system and method could be implemented with the assistance of the rig or trailer manufacturer and their dealer, thus ensuring better compliance. There is also a need to facilitate better documentation and record retention of the tires' purchase so that tire manufacturers can contact consumers if needed. In addition to improved warranty implementation, there is also a need for the tires to be associated with the rigs in such a way to facilitate purchase of replacement tires. There are also likely benefits for inventory management and for tire wear evaluation with such a system and method.

### SUMMARY OF THE INVENTION

In light of the foregoing, it is a first aspect of the present invention to provide a system and method for associating tire information with towable rig information.

It is another aspect of the present invention to provide a computerized method for associating at least one tire, a rig, and a consumer of the at least one tire and the rig with one another, comprising: receiving a tire identification number (TIN) with a tire in a database record in a database maintained by a computer; receiving a vehicle identification number (VIN) with a rig in the database record; receiving and linking by the computer at least one said TIN with the VIN in the database record when the corresponding tire is assembled to the corresponding rig to configure a trailer; and receiving a consumer identifier of the trailer in the database record for association with the corresponding tire and the corresponding rig.

It is a further aspect of the present invention to provide a computer-readable medium having stored thereon a data structure, comprising: a first field representing a tire identification number (TIN); a second field representing a vehicle identification number (VIN); and a third field representing an end-purchaser associated with the first field and the second field.

It is still another aspect of the present invention to provide a system for identifying consumers affected by a recall notice, comprising: a storage device; and a computer programmed to: maintain in the storage device a database identifying tire identification numbers (TIN), their corresponding vehicle identification numbers (VIN), and at least one corresponding consumer; receive input of recall notices associated with selected TINs; and generate electronic or paper notifications of the recall notice to the at least one corresponding consumer.

### BRIEF DESCRIPTION OF THE DRAWING

These and other features and advantages of the present invention will become better understood with regard to the following description, appended claims, and accompanying drawings wherein:

FIG. 1 is a schematic diagram showing a system and method for associating tires assembled to any towable rig according to the concepts of the present invention.

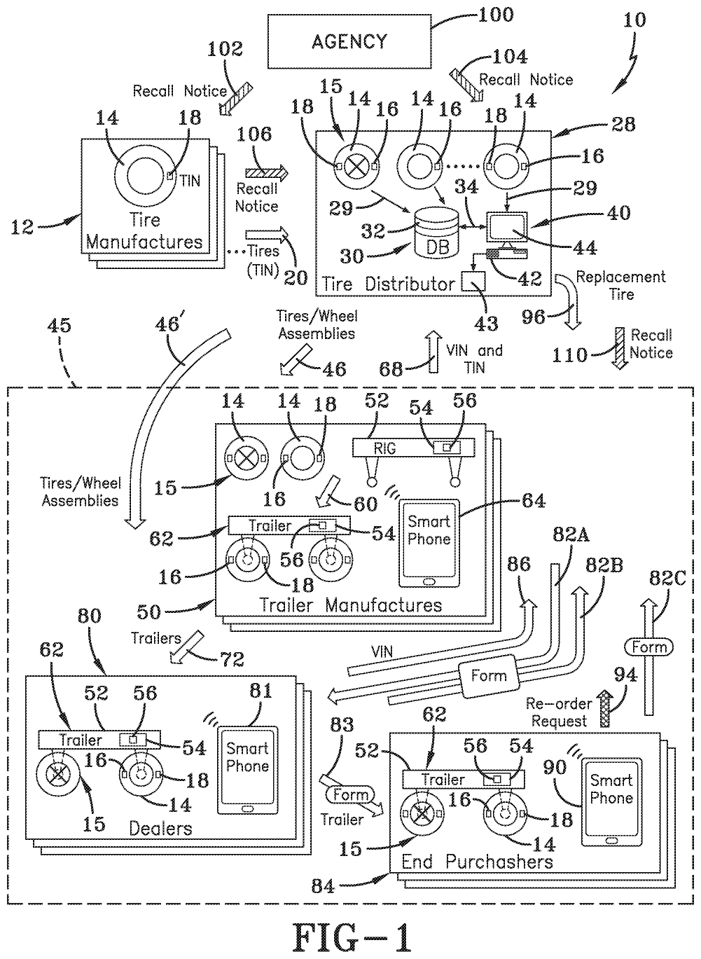

### DETAILED DESCRIPTION OF THE INVENTION

Referring now to the drawing, it can be seen that a system and method for associating tire information with towable rig information is designated generally by the numeral 10. As seen in the drawing, different business entities are represented by rectangular blocks and substantive activity between and within the entities is represented by arrows. Skilled artisans will appreciate that in some embodiments certain activity associated with one entity may be performed by other entities.

In the drawing, a tire manufacturer (or manufacturers) is designated generally by the numeral 12. The tire manufacturer manufactures any number or style of tire 14 wherein each tire manufactured includes, molded into a sidewall of the tire, or otherwise identified, at least one of the following: a plant of manufacture identification; a tire size code; a manufacture construction code; and/or a date of manufacture. This is known as a tire identification number (TIN) 18 which may include any data associated with the tire.

Once the manufacture of the tire is complete, the tires with their respective TIN may be shipped as indicated by the arrow 20 to a tire distributor designated generally by the numeral 28. Any number of tires from any number of tire manufacturers 12 may be received by the tire distributor 28. Once at the tire distributor, a tag 16 which may be in the form of a barcode, a QR code, a RFID tag, any type of optically readable indicia, or the like is secured or otherwise attached to the tire. This data or information may include, but is not limited to, the TIN, the tire size, an order number, a purchase order number, a part number, tire size, and/or a trade name. In some embodiments, the tire distributor may mount the tire 14 on to a wheel so as to form a tire/wheel assembly 15. It is also possible that the tag 16 may include a tire part number, a wheel part number, and a bead label serial number. All of this data or information may further be associated with the TIN 18 and incorporated into the tag 16 via the bar code, QR code, RFID tag, or the like.

The tire distributor 28 may then load or otherwise enter data associated with the tag 16 and/or TIN 18, as indicated by the arrow 29, into a database designated generally by the numeral 30 with or without the assistance of a storage computer 40. As will be appreciated by skilled artisans, the database 30 receives and maintains any number of data records 32, which may also be referred to as a data structure, wherein each record may be associated with the corresponding data associated with the TIN 18. The database 30 may be associated with the storage computer 40 which may provide the necessary hardware, software, and memory linked to the database 30 so as to allow for manipulation and searching of the data records 32 as needed. The software on the computer 40 may be provided on any kind of computer memory, floppy disks, conventional hard disks, flash memory, non-volatile ROM, or RAM. The software may also be provided by a server, a cloud-based server, or any other suitable computer-readable medium. Moreover, the computer may be configured to receive and maintain in the storage device the various data records disclosed herein; receive input from any source disclosed herein; generate and send electronic or paper notification via an appropriate text, other electronic means, email service, or printer; and implement or perform any other operation disclosed herein. The computer 40 may provide for an input/output device 42 which may incorporate a keyboard, a microphone, and/or any type of electronic or laser scanning device that detects the TIN 18 and/or the tag 16. The input/output devices linked to the computer 40 may also receive wired or wireless electronic communications, including but not limited to data sent from consumers as will be discussed below. Also linked to the storage computer 40 may be a display 44 for use by an operator to display the data records. The computer 40 may also be connected to a printer 43 to generate any number of reports or mailings, and be enabled to analyze the data records.

Once properly identified, tagged, and associated with records 32 in the database 30, the tires 14 and/or the tires 14 mounted on an appropriate wheel to form the tire/wheel assembly 15 are shipped or otherwise transferred, as indicated by the arrow 46 or 46′, to a consumer designated generally by the numeral 45. As used herein, the consumer 45 may be identified as a trailer manufacturer 50, a dealer 80 and/or an end-purchaser 84. Information associated with any of the consumers identified herein such as name, address, purchase date, type of consumer, and so on may be referred to as an identifier. In some embodiments the tires 14 and/or tire/wheel assembly 15 may be shipped directly to one type of consumer, such as the trailer manufacturer 50, the dealer 80, or the end-purchaser 84. In other embodiments the tire 14 and/or tire wheel assembly 15 may be routed through two of the consumers, and in still other embodiments the tire 14 and/or tire/wheel assembly 15 may be routed through all three types of consumers.

Upon receipt of an order, the tire distributor 28 may ship the selected tires, tire/wheel assembly 15, and/or wheels that may be associated with the tires with the associated tag 16 and the TIN 18, as indicated by the arrow 46 to a consumer such as a trailer manufacturer 50. The manufacturer 50, wherein the system and method 10 may incorporate multiple trailer manufacturers, receives the tires 14 and/or tire/wheel assembly 15 as a result of the shipping process 46 for further value-added steps. The manufacturers 50 either manufacture or purchase separately a rig assembly 52 wherein the rig assembly may be any towable object such as a trailer, a boat trailer, construction equipment, a recreational vehicle, generators, campers, farm implements, and the like. Each assembly 52 is provided with a tag 54 which may include any type of relevant manufacturing information such as a vehicle identification number (VIN) 56. The VIN 56 may include information such as, but not limited to, the trailer manufacturer, model number, part number, date of manufacture, and the like.

As indicated by the arrow 60, the manufacturer 50 may associate or assemble the rig assembly 52 with the tires 14 and/or tire wheel assembly 15. As such, the completed combination of the rig assembly 52 and the tires 14 configure a trailer 62. In other embodiments, the manufacturer 50 may ship the rig assembly 52 with the required number of tires 14 and/or tire/wheel assemblies uninstalled on the rig assembly 52. The manufacturer 50 may utilize an acquisition computer 64 which may comprise a camera, a scanner, and a transmitter and/or other appropriate input/output device, any or all of which may be embodied in a smart phone or other similar device. The computer 64 is identified as a “smart phone” in the drawing. Accordingly, the manufacturer 50 utilizes the acquisition computer 64 to acquire and transmit to the tire distributor 28, as indicated by the arrow 68, the VIN 56 and/or the TIN 18 along with the trailer manufacturer identifier. Accordingly, in some embodiments the VIN 56 and the TIN 18 may be linked to one another. In either case, skilled artisans will appreciate that the tire distributor 28 may receive this information via the computer 40 or other appropriate receiving device for loading into the database 30. Skilled artisans will further appreciate that the TIN for each tire may be associated with the VIN corresponding to the assembled trailer 62 in a corresponding database record 32.

As designated by the arrow 72, the manufacturer 50 ships the completed trailer 62 (with the tires and/or tire/wheel assemblies installed or unassembled on the rig) to a consumer such as a dealer designated generally by the numeral 80. Skilled artisans will appreciate that the trailers 62 may be shipped to any number of dealers 80 wherein the dealers may sell any number of trailer configurations. The dealer 80 offers the trailers for sale to end-purchasers which are designated generally by the numeral 84. If an end-purchaser 84 finds a trailer that they like and purchases it, then the trailer is transferred as designated by the arrow 83. If not already assembled to the rig assembly 52, the manufacturer 50 may install the tires 14 or tire/wheel assembly 15 on the rig.

In an alternative embodiment, the tire distributor 28 may ship or transfer the tires 14 and/or tire/wheel assemblies 15 directly to the dealers 80 as indicated by the arrow 46′. In such a scenario, the dealer 80 may assemble the tires 14 and/or the tire/wheel assembly 15 to the rig assembly 52.

At or about the time of purchase, the dealer 80 may transmit via an acquisition computer 81, as indicated by the arrow 86, the VIN 56 from the rig 52 to the tire distributor 28. The computer 81 may be similar to the acquisition computer 64 discussed above and which is identified in the drawing as a “smart phone.” Along with the VIN, the dealer 80 may transmit a dealer identifier for inclusion and receipt in the appropriate database record. The VIN 56 may be retrieved from the database 30 to find the tires and the associated TIN 18 installed on the specific trailer 62. The dealer 80 may then receive back from the distributor 28 an electronic or printed tire registration form, designated as FORM in the drawing, on the smartphone or computer with the VIN 56, the TIN 18 as indicated by the arrow 82A, and may then enter the end-purchaser's name and information required on the FORM to register the tires for warranty and recall. In some embodiments, issuance of the registration form may be required by a government agency as discussed below. In some instances, the form may be required by a government agency. Once completed, the dealer may send the completed electronic FORM, as indicated by the arrow 82B, to the tire distributor 28. In the alternative, the FORM may be sent by regular mail. In either scenario, the information on the FORM is then received and uploaded to the database 30 and the pertinent records 32 are updated. The benefit for the dealer 80 transmitting this information and their identifier to the tire distributor 28 is that it simplifies their reporting requirements to the trailer manufacturer and also provides the tire distributor with data associated with the tires, the trailer, and the end-purchaser.

The end-purchaser 84, which most likely possesses a similar acquisition computer 90 or smart phone, which may be similar to the computer 64 discussed above, and may scan the tag provided either on the tire and/or the trailer 62. In the event the dealer 80 does not return the FORM to the tire distributor 28 as designated by the arrow 82B, then the end-purchaser 84 may fill in the FORM and send the completed electronic FORM along with their identifying information, as designated by the arrow 82C to the tire distributor 28. In the alternative, the FORM may be printed and sent by regular mail. In either scenario, the information is received and uploaded by the distributor to the database 30 and the pertinent records 32 are updated. In any event, with this information the end-purchaser may also place any type of re-order request with the tire distributor 28 when their tires become worn, as indicated by the arrow 94. In reply, the tire distributor 28 may then ship replacement tires, as designated by the arrow 96, to the purchaser 84 directly or through an intermediary as appropriate. In other embodiments, the end-purchaser 84 may check tire distributor records to verify their tires are registered for warranty and recall.

It will further be appreciated that the system and method 10 may incorporate an agency 100 that monitors the quality of all tire models based on complaints received or other evaluations. In the United States, such an agency 100 is the National Highway Traffic Safety Administration which oversees all regulatory issues related to tire and vehicle safety recalls. Accordingly, whenever a tire model is deemed to be defective in any way, the agency 100 may issue a recall notice to the tire manufacturers as designated by the arrow 102 and a recall notice to the tire distributor as designated by the arrow 104. In some embodiments, the recall notice may be transferred from the tire manufacturer 12 to the tire distributor 28 as designated by the arrow 106. Upon receipt of such a notice, the tire distributor will issue a recall notice, as designated by the arrow 110 directly to the purchaser 84 based on all of the information stored and maintained in the database 30.

The advantages of the present system 10 and associated method are readily apparent. The tire distributor now has an improved way for tracking consumers including end-purchasers and can quickly issue quickly recall notices, whereas in the past such recall notices were ignored or discarded. Indeed, the present system 10 removes the likely possibility of human error in attempting to coordinate hundreds of thousands of records or more associated with the sale of tires and associated trailers. The likelihood of human error in previous systems was further compounded by the number of different entities required to provide the needed information in a consistent and standardized format. Moreover, the abysmal participation rate of the prior system is clear evidence that the present system is a clear improvement in the technology. With the system and method in place, the end-purchaser 84 can be easily notified that they have defective tires and can obtain replacements, thus improving the safety of their trailer and the related benefits associated therewith. The system is also advantageous in that the tire distributor can track the presumed wear properties of the tires shipped and can send sale notices to both the end-purchaser and the tire manufacturers so as to facilitate ordering of new tires that are assured to be associated and properly fit with the trailer configuration that is owned by the end-purchaser. The information collected in the database 30 may also be used to identify trends and/or safety issues with particular tires, trailers, and/or combinations of rigs and tires. In sum, the present system 10 and related features provide a new and improved way of associating disparate information into a usable format over any previously known system.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A computerized method for associating at least one tire, a rig, and a consumer of the at least one tire and the rig with one another, comprising:
receiving a tire identification number (TIN) with a tire in a database record in a database maintained by a computer;
receiving a vehicle identification number (VIN) with a rig in said database record;
receiving and linking by said computer at least one said TIN with said VIN in said database record when the corresponding tire is assembled to the corresponding rig to configure a trailer; and
receiving a consumer identifier of said trailer in said database record for association with the corresponding tire and the corresponding rig.

2. The method according to claim 1, further comprising:
receiving in said database record a trailer manufacturer identifier, wherein the trailer manufacturer configures said trailer with said tire.

3. The method according to claim 1, further comprising:
selecting said consumer identifier from the group consisting of a trailer manufacturer identifier, a dealer identifier, an end-purchaser identifier, and any combination thereof.

4. The method according to claim 3, further comprising:
receiving said end-purchaser identifier of said trailer in said database record for association with the corresponding tire and the corresponding rig.

5. The method according to claim 3, further comprising:
performing at least one of said receiving steps at a tire distributor who maintains said database.

6. The method according to claim 5, further comprising:
receiving a tire recall notice in said computer;
checking said database records by said computer for end-purchasers of tires that are identified in said tire recall notice; and
sending by said computer said recall notice to identified end-purchasers.

7. A computer-readable medium having stored thereon a data structure, comprising:
a first field representing a tire identification number (TIN);
a second field representing a vehicle identification number (VIN); and
a third field representing an end-purchaser associated with said first field and said second field.

8. The data structure according to claim 8, further comprising:
a fourth field representing a recall notice associated with selected TINs in said first field, wherein said first field comprises at least one of a tire size code, a construction code, and date of manufacture.

9. A system for identifying consumers affected by a recall notice, comprising:
a storage device; and
a computer programmed to:
maintain in said storage device a database identifying tire identification numbers (TIN), their corresponding vehicle identification numbers (VIN), and at least one corresponding consumer;
receive input of recall notices associated with selected TINs; and
generate electronic or paper notifications of the recall notice to said at least one corresponding consumer.

10. The system according to claim 9, wherein said at least one corresponding consumer is selected from the group consisting of at least one trailer manufacturer, at least one dealer, and at least one end-purchaser.

11. The system according to claim 10, wherein said computer is programmed to receive from said at least one consumer the TIN and the VIN.

12. The system according to claim 10, wherein said computer is programmed to receive contact information from said at least one consumer in association with at least one of the TIN and the VIN.

13. The system according to claim 10, wherein said computer is programmed to issue re-order forms at designated times or whenever recall notices are issued for selected TINs.

14. The system according to claim 10, wherein said computer is programmed to:
receive from said at least one consumer the TIN and the VIN;
receive contact information from said at least one consumer in association with at least one of the TIN and the VIN; and
issue re-order forms at designated times or whenever recall notices are issued for selected TINs.
